(19) United States
(12) Patent Application Publication
(10) Pub. No.: US 2016/0356049 A1
(43) Pub. Date: Dec. 8, 2016

(54) Adjustable Drywall Corner Finishing Tool

(71) Applicant: Ricky D. Potter, Neosho, MO (US)

(72) Inventor: Ricky D. Potter, Neosho, MO (US)

(21) Appl. No.: 14/733,074

(22) Filed: Jun. 8, 2015

(51) Int. Cl. E04F 21/165; B25G 3/38

(52) U.S. Cl. CPC E04F 21/1655; E04F 21/1657; B25G 3/38

(57) ABSTRACT

A drywall installation tool. The present drywall installation tool is specifically adapted for evenly applying drywall mud and drywall tape in corners between adjoining sections of drywall. The present tool includes a pair of hingedly connected blades that each have a scraping member for smoothing drywall mud or drywall tape as the tool is drawn over the sections of drywall and one or more rollers. The tool further includes an adjustment mechanism configured to adjust the angle between the blades, thereby allowing the present tool to accommodate corners of any angle. The tool further includes a receptacle into which drywall mud or other tape can be placed that is in fluid communication with the exterior surface of the head of the tool, thereby dispensing any material therein as the head is drawn over a surface. Furthermore, a handle is pivotably connectable to the tool head.

### FIELD OF THE INVENTION

The present invention relates to drywall installation tools. More specifically, the present invention relates to drywall installation tools that are adapted for the application and smoothing of drywall mud and drywall tape in corners.

### BACKGROUND OF THE INVENTION

Finishing nonstandard, i.e. not right-angled, corners between sections of drywall or a section of drywall and another surface can be a time-consuming and frustrating process because conventional drywall installation tools are not configured for use with nonstandard corners. Therefore, individuals are forced to manually apply drywall mud and tape and then manually smooth out the material. In addition to being laborious, manually performed drywall work is also rarely as clean and aesthetically pleasing as drywall work performed with a tool. Therefore, there is a need in the prior art for a drywall installation tool that is adapted for finishing corners wherein the adjoining sections of drywall are joined at nonstandard angles.

### SUMMARY OF THE INVENTION

In view of the foregoing disadvantages inherent in the known types of drywall installation tools now present in the prior art, the present invention provides an adjustable drywall corner finishing tool wherein the same can be utilized for providing convenience for the user when finishing drywall corners that are nonstandard, i.e. not right-angled. The present system comprises a pair of hingedly connected blades that each have a scraping member for smoothing drywall mud or drywall tape as the tool is drawn over the sections of drywall and one or more rollers. The tool further includes an adjustment mechanism configured to adjust the angle between the blades, thereby allowing the present tool to accommodate corners of any angle. The tool further includes a receptacle into which drywall mud or other tape can be placed that is in fluid communication with the exterior surface of the head of the tool, thereby dispensing any material therein as the head is drawn over a surface. Furthermore, a handle is pivotably connectable to the present tool.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the interior of the present invention.

FIG. 1B shows a perspective view of the exterior of the present invention.

FIG. 2 shows a cross-sectional view of the present invention along line 2-2, as applied to a wall.

### DETAILED DESCRIPTION OF THE INVENTION

Reference is made herein to the attached drawings. Like reference numerals are used throughout the drawings to depict like or similar elements of the drywall mud and tape finisher for corners. For the purposes of presenting a brief and clear description of the present invention, the preferred embodiment will be discussed as used for applying drywall mud and tape to the corners between sections of drywall. The figures are intended for representative purposes only and should not be considered to be limiting in any respect.

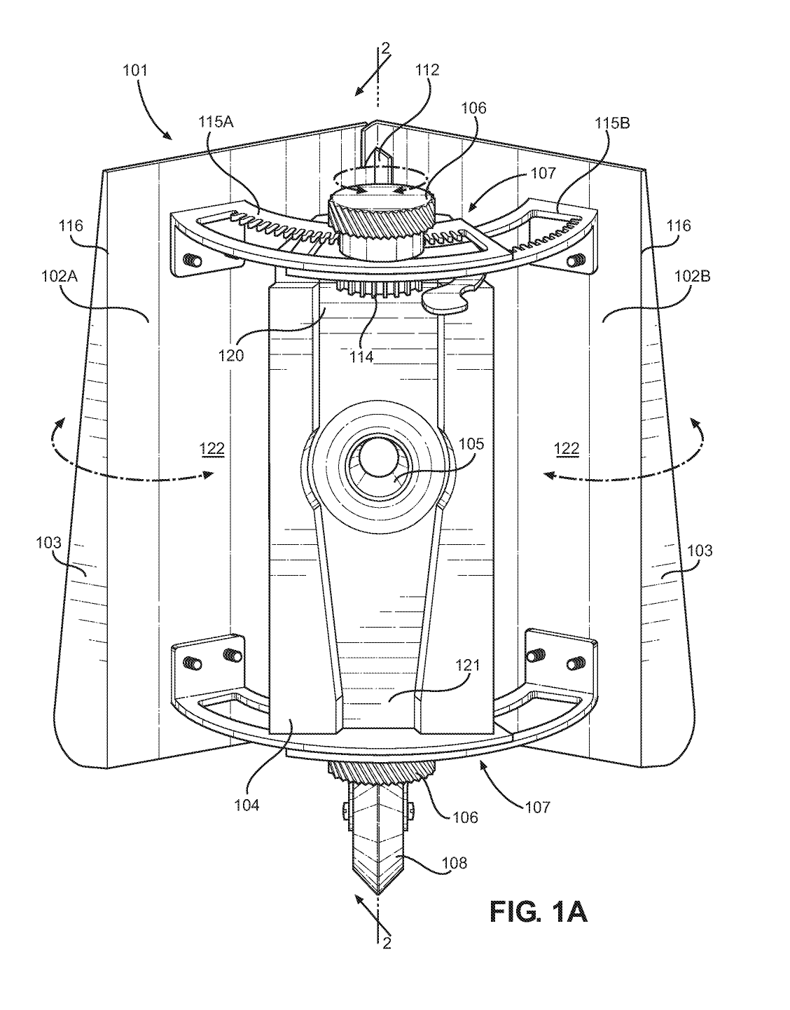

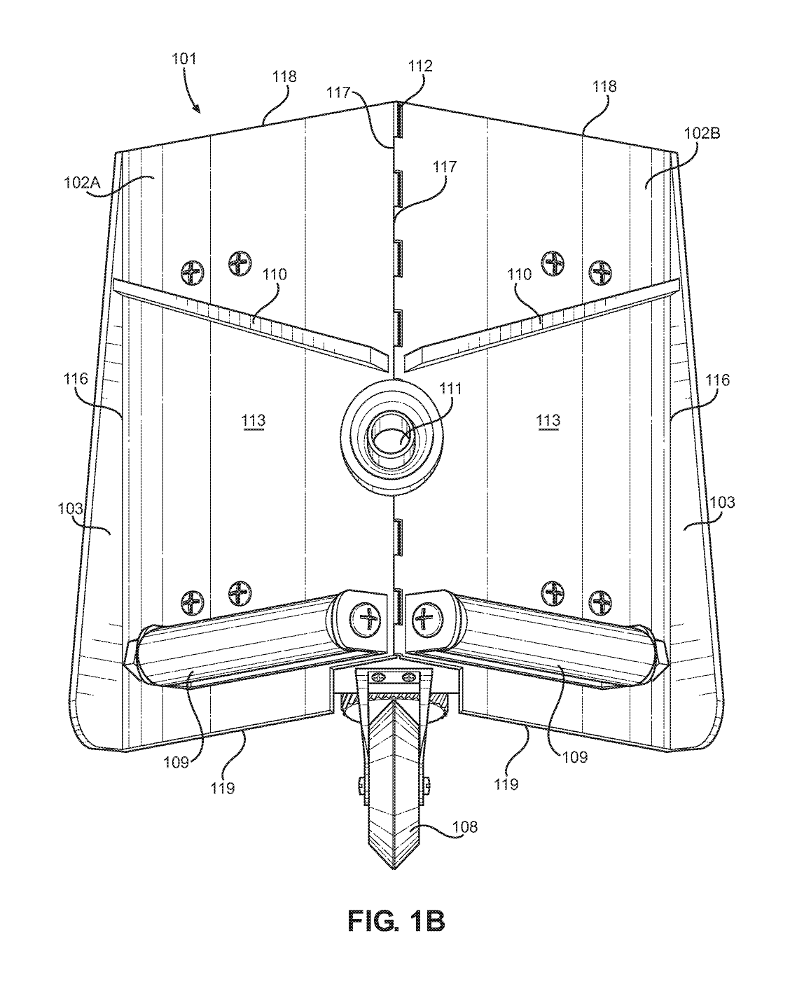

Referring now to FIGS. 1A and 1B, there are shown perspective views of the interior and exterior of the present invention. The present invention is a drywall finishing tool that is adapted to evenly apply material, e.g. drywall mud and tape, at the corners between surfaces, e.g. sections of drywall. The head 101 of the present drywall corner finishing tool comprises a first blade 102A and a second blade 102B that are hingedly connected 112 together at their proximal lateral edges 117, a connector 105 to which a handle is connectable, and an adjustment mechanism 107 that allows for the angle between the first and second blades 102A, 102B to be adjusted relative to each other. The blades 102A, 102B are planar members comprising an interior surface 122 to which the adjustment mechanism 107 is connected and an exterior surface 113 that is adapted to be drawn across the surfaces of sections of drywall in order to evenly apply drywall mud and/or drywall tape thereacross.

The head 101 of the drywall finishing tool is adapted smooth out drywall tape and drywall mud as the head 101 is drawn across a pair of adjacent sections of drywall, or other such surfaces, that are joined at a corner. The exterior portion of the head 101, as shown in FIG. 1B, functions as a drywall mud and tape distribution and smoothing surface. The head 101 comprises a roller 109 disposed on the exterior surface 113 of the blades 102A, 102B adjacently to a second longitudinal edge 119 and a scraping member 110 disposed on the exterior surface 113 of the blades 102A, 102B at a point between the roller 109 and the first longitudinal edge 118. The rollers 109 are adapted to assist in the head 101 being drawn across a surface, i.e. a section of drywall, by reducing the friction between the exterior surface 113 of the head 101 and the surface as the head 101 is drawn thereacross. The head 101 is adapted to be drawn across a surface such that the rollers 109 lead the direction of movement and the scraping members 110 trail therebehind, smoothing out the drywall mud and/or tape as the head 101 is dragged across the surface. In an illustrative embodiment of the present invention, the rollers 109 comprise elongated cylindrical members that are rotatably connected to a bracket, which is in turn affixed to the exterior surface 113 of the head 101 such that the bracket extends perpendicularly therefrom.

In an illustrative embodiment of the present invention, the scraping members 110 are disposed at an angle relative to the longitudinal axis of the blades 102A, 102B. This allows the scraping members 110 to redirect material from the midline of the head 101 towards the distal lateral edges 116, thereby ensuring that the material is evenly spread across the adjacent surfaces and is not accumulated in the corner as the head 101 is drawn thereacross. The head 101 further comprises a shoulder 103 extending perpendicularly from a distal lateral edge 116 of the exterior surface 113 of each of the blades 102A, 102B. The shoulder 103 is adapted to prevent material from leaking from the lateral sides of the head 101 as the head 101 is drawn across a surface. In an illustrative embodiment of the present invention, the height of the shoulder 103 is variable along its length, tapering from the second longitudinal edge 119 to the first longitudinal edge 118.

The head 101 further comprises a receptacle 111 disposed between the blades 102A, 102B having an interior volume into which drywall mud, mastic material, and other such materials can be placed for distribution. The receptacle 111 comprises a first open end disposed on the exterior portion of the head 101, a second open end disposed on the interior portion of the head 101, and a channel extending therebetween. In an illustrative embodiment of the present invention, the receptacle 111 extends through a central member 104 that is connected to the interior surfaces 122 of the blades 102A, 102B. The receptacle 111 is in fluid communication with the exterior portion of the head 101, thereby allowing material placed within the receptacle 111 to be dispensed therefrom as the head 101 is drawn across a surface. The receptacle 111 is disposed at a position between the scraping members 110 and the second longitudinal edge 119, thereby allowing the scraping members 110 to smooth material as it is dispensed from the receptacle 111.

The adjustment mechanism 107 is adapted to allow the angle between the blades 102A, 102B to be adjusted so that users can customize the shape of the head 101 to accommodate corners wherein the adjoining surfaces, i.e. a pair of walls or a wall and a ceiling, are not joined at a right angle. In an illustrative embodiment of the present invention, the adjustment mechanism 107 comprises a knob 106 operatively connected to a pinion 114, which is in turn engaged with a first rack 115A extending from the first blade 102A and a second rack 115B extending from the second blade 102B. The racks 115A, 115B are gear bars that are arcuate in shape and comprise a plurality of teeth adapted to engage the teeth of the pinion 114. Rotation of the pinion 114, via actuation of the knob 106, causes the racks 115A, 115B to move in relation thereto, moving the blades 102A, 102B. In one embodiment of the present invention, the angle between the blades 102A, 102B is adjustable from approximately 45 degrees to 160 degrees. The first and second racks 115A, 115B comprise the same size and distribution of teeth, thereby ensuring that the rate at wish the first and second blades 102A, 102B move with respect to each other is the same. The depicted embodiment of the present invention comprises two sets of adjustment mechanisms 107 disposed at each of the opposing ends of the head 101; however, no claim is made as to the precise number or arrangement of the adjustment mechanism 107.

The head 101 further comprises a central member 104 disposed on the interior portion of the head 101. The central member 104 supports the connector 105 to which a handle is connectable. In the depicted embodiment of the present invention, the central member 104 comprises a first end 121 connected a first adjustment mechanism 107 and a second end 122 connected to a second adjustment mechanism. The pinion 114 is rotatably connected to central member 104 and rotation of the pinion 114 causes the first and second racks 115A, 115B to move in relation thereto.

The connector 105 comprises any type of rotatable or pivotable connection known in the prior art. In the depicted embodiment of the present invention, the connector 105 comprises a socket adapted to retain a ball bearing therein, i.e. a ball joint connection. The socket of the connector 105 comprises a semi-spherical shape having a diameter in closer tolerance to the diameter of the ball with which it is adapted to engage, such that the ball is freely pivotable and yet securely retained therein.

In an illustrative embodiment of the present invention, the connector 105 overlays the material receptacle 111 such that the ball of the handle blocks the second open end of the receptacle 111 when the handle is secured to the head 101 via the connector 105. This allows users to place material, e.g. drywall mud, within the receptacle 111, connect the handle to the head 101, and then have material distributed from the receptacle 111 to the exterior surfaces 113 of the blades 102A, 102B as the head 101 is drawn across a surface, without the material leaking onto the inter portion of the head 101.

An alternative embodiment of the present invention further comprises one or more guide wheels 108 adapted to assist in steadying the head 101 as it is drawn across a surface. In the depicted embodiment of the present invention, the guide wheel 108 extends from the second end 122 of the central member 104. The guide wheel 108 is positioned such that it bisects the first and second blades 102A, 102B so that it rests within a corner when the head 101 is placed thereagainst, helping to prevent lateral movement of the head 101 as it is drawn through the corner between the adjoining surfaces. In an alternative embodiment of the present invention, the guide wheel 108 comprises a tapered shape that allows it to fit tightly within a corner.

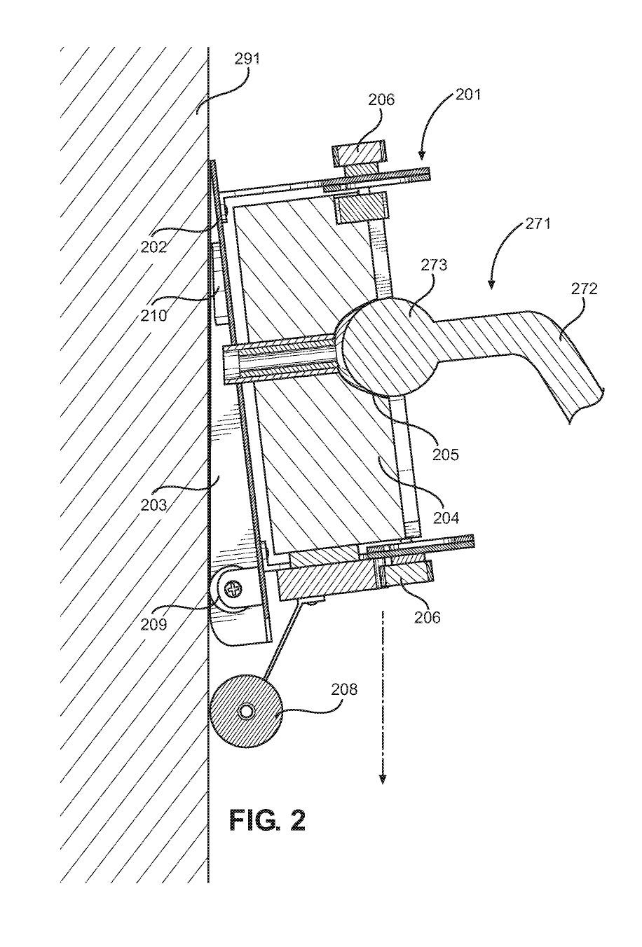

Referring now to FIG. 2, there is shown a cross-sectional view of the present invention along line 2-2, as applied to a wall. When the head 201 is pressed against a surface 291, e.g. a section of drywall, the blade 202, shoulder 203, roller 209, and scraping member 210 form a partially enclosed interior volume against the surface 291. The height of the shoulder 203 at the point adjacent to the roller 209 is equal to the height of the roller 209 within a closer tolerance. The height of the shoulder 203 at the point adjacent to the scraping member 210 is slightly larger than the height of the scraping member 210, thereby creating a gap between the scraping member 210 and the surface 291 against which the head 201 is pressed. The gap therebetween allows the scraping member 210 to level material on the surface 291 as the head is drawn over the material on the surface 291.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A device, comprising:
a first blade hingedly connected to a second blade, each of the first blade and the second blade comprising an exterior surface, a scraping member disposed on the exterior surface, and a roller disposed on the exterior surface;
an adjustment mechanism adapted to adjust an angle between the first blade and the second blade;
a connector to which a handle is pivotably connectable.

2) The device of claim 1, wherein the adjustment mechanism comprises:
a first arcuate rack extending from the first blade;
a second arcuate rack extending from the second blade;
a knob operatively connected to a pinion, the pinion engaged with the first arcuate rack and the second arcuate rack;
wherein actuation of the knob adjusts the angle between the first blade and the second blade.

3) The device of claim 1, further comprising a shoulder extending perpendicularly from a distal lateral edge of each of the first blade and the second blade.

4) The device of claim 3, wherein the shoulder tapers from a second end of each of the first blade and the second blade to a first end of each of the first blade and the second blade.

5) The device of claim 1, wherein a height of the scraping member is less than a height of the roller.

6) The device of claim 5, wherein:
the shoulder tapers from a second end of each of the first blade and the second blade to a first end of each of the first blade and the second blade;
the shoulder comprises a first point along thereof adjacent to the scraping member and a second point along thereof adjacent to the roller;
a height of the first point is equal to the height of the scraping member and a height of the second point is equal to the height of the roller.

7) The device of claim 1, wherein the scraping member is disposed at an angle relative to a longitudinal axis of each of the first blade and the second blade.

8) The device of claim 1, wherein the connector comprises a ball joint connector.

9) The device of claim 8, further comprising a handle pivotably connected to the device via the ball joint connector.

10) The device of claim 1, further comprising a guide wheel.

11) The device of claim 10, wherein the guide wheel is centrally aligned.

12) The device of claim 1, wherein the scraping member and the roller are in a spaced relationship.

13) The device of claim 1, wherein the first blade and the second blade are planar members.

14) The device of claim 1, further comprising:
a receptacle comprising a first open end, a second open end, and a channel extending therebetween;
wherein the first open end is disposed between the exterior surface of the first blade and the exterior surface of the second blade, such that the channel is in fluid communication therewith;
wherein the second open end is disposed on an interior surface of the head.

15) The device of claim 14, wherein the connector overlays the second open end, such that when a handle is affixed to the connector, the handle blocks the second open end.

16) The device of claim 1, wherein the scraping member extends from a proximal lateral edge of the exterior surface to a distal lateral edge of the exterior surface.

17) A device, comprising:
a head comprising an interior surface, a first blade, and a second blade;
each of the first blade and the second blade comprising a proximal lateral edge, an exterior surface, a scraping member disposed on the exterior surface at an angle relative to a longitudinal axis thereof, and a roller disposed on the exterior surface;
wherein the first blade and the second blade are planar members hingedly connected at each proximal lateral edge;
an adjustment mechanism affixed to the interior surface, the adjustment mechanism comprising a first arcuate rack extending from the first blade, a second arcuate rack extending from the second blade, and a pinion engaged with the first arcuate rack and the second arcuate rack;
wherein actuation of the pinion adjusts an angle between the first blade and the second blade;
a receptacle comprising an open end disposed adjacently to the exterior surface of each of the first blade and the second blade;
a handle connected to the interior surface of the head via a pivotable connection.

18) The device of claim 17, wherein the pivotable connection overlays a second open end of the receptacle, thereby sealing the second open end.

19) The device of claim 17, wherein the pivotable connection comprises a ball joint.

20) The device of claim 17, wherein:
the adjustment mechanism comprises a first adjustment mechanism and a second adjustment mechanism;
a central member extends between the first adjustment mechanism and the second adjustment mechanism, the central member comprising the pivotable connection thereon.
